(19) United States
(12) Patent Application Publication
(10) Pub. No.: US 2026/0296663 A1
(43) Pub. Date: Oct. 1, 2026

(54) INLET CONE AND AERO-ENGINE COMPRISING SAME

(71) Applicant: AECC COMMERCIAL AIRCRAFT ENGINE CO., LTD., Shanghai (CN)

(72) Inventors: Jie SU, Shanghai (CN); Zhongtao HUANG, Shanghai (CN); Jieshan ZHANG, Shanghai (CN)

(73) Assignee: AECC COMMERCIAL AIRCRAFT ENGINE CO., LTD., Shanghai (CN)

(21) Appl. No.: 18/998,162

(22) PCT Filed: Jul. 24, 2023
(86) PCT No.: PCT/CN2023/108972

§ 371 Date: Jan. 24, 2025

(30) Foreign Application Priority Data
Jul. 26, 2022 (CN) 202210883589.9

(51) Int. Cl. B64D 33/02

(52) U.S. Cl. CPC B64D 33/02; B64D 2033/0233

(57) ABSTRACT

An inlet cone comprising a main body and a nose cone portion. Cold air flows towards an outer wall at the rear along an outer side surface of the nose cone portion, and since the outer side surface of the outer wall is curved and drawn down towards the axis of the main body in the direction away from an first outer profile line of the nose cone portion, an air stagnation area is formed between an extension line of the first outer profile line and an second outer profile line of the outer wall, and there is less cold air flowing in the air stagnation area, such that the outer wall of the inlet cone is less prone to icing up, thereby improving the engine efficiency.

### TECHNICAL FIELD

The present disclosure belongs to the technical field of anti-freezing of aero-engine cowls, and in particular relates to an inlet cone and an aero-engine comprising same.

### BACKGROUND

During flight of an aircraft, its engine is exposed to low temperatures, which may cause icing over a surface thereof. Icing has a serious impact on flight safety, especially for aero-engines. Once icing occurs, it will cause poor air intake and thus reduce the operating efficiency of the engine, and even cause mechanical damage to an engine intake system due to large-scale ice shedding in severe cases, resulting in engine stall to cause serious safety accidents. An inlet cone, as a front-end component of the engine intake system, is directly exposed to outside airflow. In an existing inlet cone, a front section wall and a rear section wall are located in the same plane, such that ice crystals are easily formed by cold air on a surface of the rear section wall, causing icing.

### SUMMARY OF THE DISCLOSURE

The technical problem to be solved by the present disclosure is to provide an inlet cone and an aero-engine including same, in order to overcome the defect of an inlet cone in the prior art of being prone to icing at a rear end thereof.

According to the present disclosure, the above technical problem is solved through the following technical solution:
an inlet cone, including a main body and a nose cone portion, wherein the main body comprises an outer wall; the nose cone portion is connected to an end portion of the outer wall; and an outer side surface of the nose cone portion has a first outer profile line, and an outer side surface of the outer wall has a second outer profile line, the second outer profile line being curved and drawn down towards an axis of the main body in a direction away from the first outer profile line.

In this solution, cold air flows towards the outer wall at the rear along the outer side surface of the nose cone portion, and since the outer side surface of the outer wall (i.e., the second outer profile line) is curved and drawn down towards the axis of the main body in the direction away from the first outer profile line, an air stagnation area is formed between an extension line of the first outer profile line and the second outer profile line, and there is less cold air flowing in the air stagnation area, that is, the heat taken away by the cold air from the surface of the outer wall is correspondingly reduced, such that the outer wall of the inlet cone is less prone to icing up, thereby improving the engine efficiency.

Preferably, the second outer profile line is smoothly joined with and tangent to the first outer profile line.

In this solution, the outer side surface of the nose cone portion is smoothly tangent to the outer side surface of the outer wall, so that when air flows along the outer surface of the inlet cone, the resistance to the air is small, and thus the engine efficiency is higher.

Preferably, the main body further comprises an inner wall arranged at the end portion of the outer wall, and a through hole is formed in the inner wall; and the nose cone portion is sleeved on an outer side of the inner wall in a clearance-fit manner to form an airflow channel, and an air hole is formed in the nose cone portion.

The through hole is formed in the inner wall, and the nose cone portion is sleeved on the outer side of the inner wall in a clearance-fit manner. With this structure, the airflow channel is in communication with the inside of the inner wall, and hot air in an air compressor can be introduced into the airflow channel via the through hole, so that the nose cone portion is heated, preventing icing over the nose cone portion. The air hole is further formed in the nose cone portion, so that hot air in the airflow channel can flow to the outer side of the nose cone portion via the air hole to neutralize the outside cold air, further preventing icing over the nose cone portion. Also, the hot air flowing to the outside flows towards the outer side surface of the outer wall under the action of the airflow so as to heat the outer side surface of the outer wall, which can also prevent icing over the outer side surface.

Preferably, the inner wall is cone-shaped and has a cone tip facing the nose cone portion, and the through hole is arranged at a conical tip portion of the inner wall.

With this structure, the airflow channel between the nose cone portion and the inner wall is narrow, and the through hole may be as close to the nose cone portion as possible, so as to prevent heat loss of the hot air in the airflow channel and achieve better heating effect of the hot air on the nose cone portion.

Preferably, two or more through holes are provided.

Providing two or more through holes can extend the range of hot air injection to further improve the heating effect on the nose cone portion.

Preferably, the plurality of through holes are evenly arranged and equally spaced at the conical tip portion of the inner wall.

The through holes being evenly arranged and equally spaced at the conical tip portion of the inner wall can achieve more uniform hot air injection to prevent icing due to a certain area of the nose cone portion not being heated by the hot air.

Preferably, the air hole is arranged at an end portion of the nose cone portion close to the outer wall.

The air hole being arranged at one end of the nose cone portion close to the outer wall enables the hot air to flow to the outer surface of the outer wall immediately after flowing out of the airflow channel, so as to prevent decrease of the heating effect on the outer wall due to heat loss of the hot air after staying in the outside for a long time. In addition, since the through hole is arranged at the cone tip of the inner wall, the hot air flows through a longer path in the airflow channel, which is also conducive to improving the heating effect on the nose cone portion.

Preferably, a plurality of air holes are provided and are evenly arranged in a circumferential direction of the nose cone portion.

With this structure, the hot air flows more uniformly in the direction from the airflow channel to the outside, which can heat the outer wall more fully, preventing local icing over the outer wall.

Preferably, the main body further comprises a transition section, the inner wall is connected to the outer wall via the transition section, and an angle between the transition section and an axial extending line of the inlet cone is an acute angle.

The transition section slopes up and is connected to the outer wall, and the hot air flows out of the air hole along the transition section when flowing from the airflow channel to the outside. On the one hand, the resistance to the hot air is small when the hot air flows out, and on the other hand, the hot air flows out in a direction that is inclined towards the outer wall, which prevents heat waste due to the outer wall being unable to be exposed to the hot air that is blown vertically upwards.

Preferably, the air hole is an inclined hole having an inclination angle the same as the angle of the transition section.

The resistance to the hot air flowing out of the air hole along the transition section is smaller, achieving higher directionality.

Provided is an aero-engine including an inlet cone described above.

Cold air flows towards the outer wall at the rear along the outer side surface of the nose cone portion of the inlet cone of the aero-engine, and since the outer side surface of the outer wall (i.e., the second outer profile line) is curved and drawn down towards the axis of the main body in the direction away from the first outer profile line, an air stagnation area is formed between an extension line of the first outer profile line and the second outer profile line, and there is less cold air flowing in the air stagnation area, that is, the heat taken away by the cold air from the surface of the outer wall is correspondingly reduced, such that the outer wall of the inlet cone is less prone to icing up, thereby improving the engine efficiency.

The present disclosure has the following positive and progressive effects. Cold air flows towards the outer wall at the rear along the outer side surface of the nose cone portion, and since the outer side surface of the outer wall (i.e., the second outer profile line) is curved and drawn down towards the axis of the main body in the direction away from the first outer profile line, an air stagnation area is formed between an extension line of the first outer profile line and the second outer profile line, and there is less cold air flowing in the air stagnation area, that is, the heat taken away by the cold air from the surface of the outer wall is correspondingly reduced, such that the outer wall of the inlet cone is less prone to icing up, thereby improving the engine efficiency.

### BRIEF DESCRIPTION OF THE DRAWINGS

FIG. 1 is a schematic structural diagram of an inlet cone according to an embodiment of the present disclosure.

FIG. 2 is another schematic structural diagram of an inlet cone according to an embodiment of the present disclosure.

FIG. 3 is a further schematic structural diagram of an inlet cone according to an embodiment of the present disclosure.

FIG. 4 is a schematic structural diagram of an inner wall of the inlet cone according to the present disclosure.

### LIST OF REFERENCE SIGNS

Nose cone portion 1
Air hole 11
Main body 2
Outer wall 21
Inner wall 22
Through hole 221
Airflow channel 3
Transition section 23
First outer profile line 3
Second outer profile line 4

### DETAILED DESCRIPTION

The present disclosure is further illustrated below by way of embodiments, but is not thus limited within the scope of the embodiments.

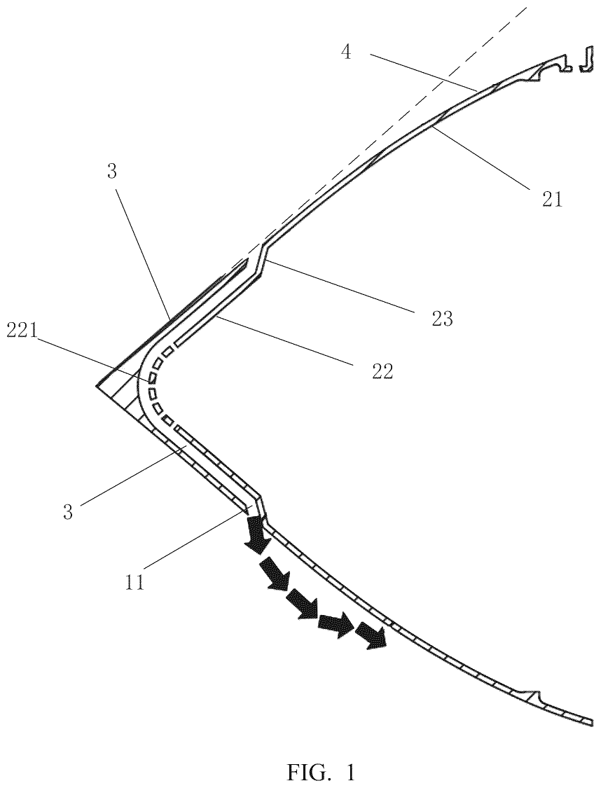

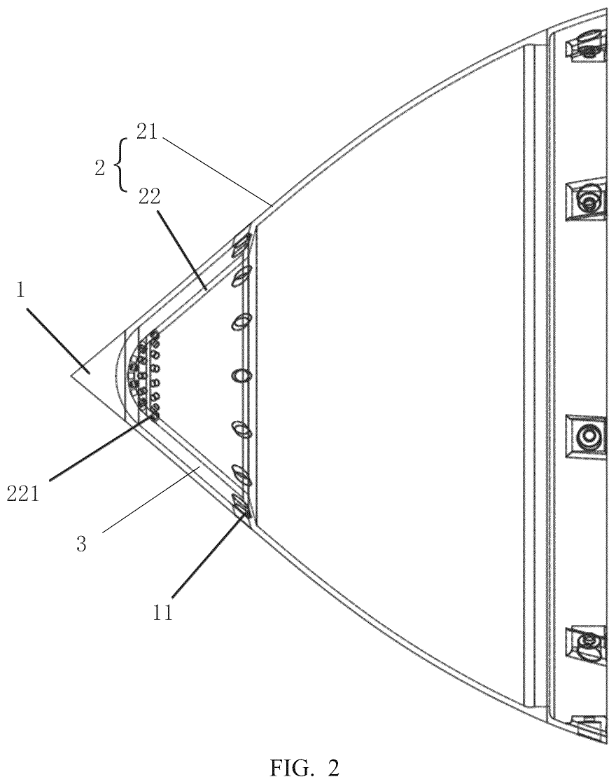

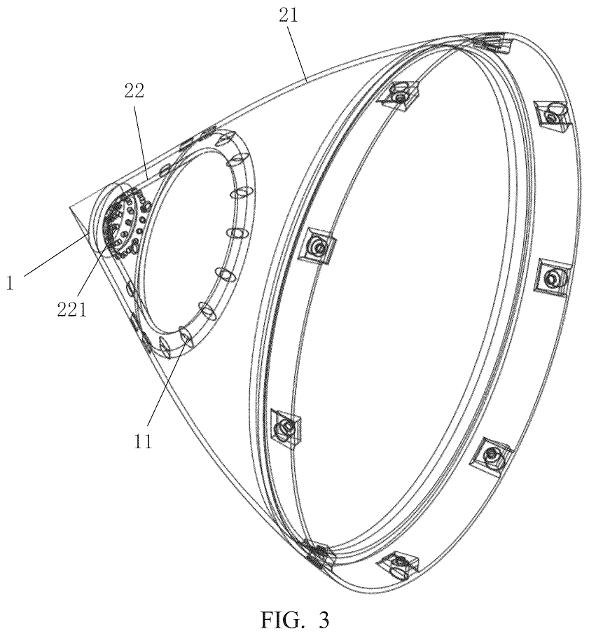

Referring to FIGS. 1 to 3, an inlet cone is provided according to an embodiment. The inlet cone comprises a main body 2 and a nose cone portion 1, wherein the main body 2 comprises an outer wall 21; the nose cone portion 1 is connected to an end portion of the outer wall 21; and an outer side surface of the nose cone portion 1 has a first outer profile line 3, and an outer side surface of the outer wall 21 has a second outer profile line 4, the second outer profile line 4 being curved and drawn down towards an axis of the main body 2 in a direction away from the first outer profile line 3.

In this embodiment, cold air flows towards the outer wall 21 at the rear along the outer side surface of the nose cone portion 1, and since the outer side surface of the outer wall 21 (i.e., the second outer profile line 4) is curved and drawn down towards the axis of the main body 2 in the direction away from the first outer profile line 3, an air stagnation area is formed between an extension line of the first outer profile line 3 and the second outer profile line 4, and there is less cold air flowing in the air stagnation area, that is, the heat taken away by the cold air from the surface of the outer wall 21 is correspondingly reduced, such that the outer wall 21 of the inlet cone is less prone to icing up, thereby improving the engine efficiency.

As shown in FIG. 1, as a preferred embodiment, the second outer profile line 4 is smoothly joined with and tangent to the first outer profile line 3.

In this embodiment, the outer side surface of the nose cone portion 1 is smoothly tangent to the outer side surface of the outer wall 21, so that when air flows along the outer surface of the inlet cone, the resistance to the air is small, and thus the engine efficiency is higher. Of course, in other embodiments, the nose cone portion 1 and the outer wall 21 may be connected together by means of an internal component, that is, the second outer profile line 4 may be spaced apart from the first outer profile line 3 to form an annular air discharge duct, as long as an air stagnation area can be formed between the extension line of the first outer profile line 3 and the second outer profile line 4.

As a preferred embodiment, the main body 2 further includes an inner wall 22. The inner wall 22 is arranged at the end portion of the outer wall 21, and a through hole 221 is formed in the inner wall 22. The nose cone portion 1 is sleeved on the outer side of the inner wall 22 in a clearance-fit manner to form an airflow channel 3 (see FIG. 1), and an air hole 11 is formed in the nose cone portion 1.

The through hole 221 is formed in the inner wall 22, and the nose cone portion 1 is sleeved on the outer side of the inner wall 22 in a clearance-fit manner. With this structure, the airflow channel 3 is in communication with the inside of the inner wall 22, and hot air in an air compressor can be introduced into the airflow channel 3 via the through hole 221, so that the nose cone portion 1 is heated, preventing icing over the nose cone portion 1. The air hole 11 is further formed in the nose cone portion 1, so that hot air in the airflow channel 3 can flow to the outer side of the nose cone portion 1 via the air hole 11 to neutralize the outside cold air, further preventing icing over the nose cone portion 1. Also, the hot air flowing to the outside flows towards the outer side surface of the outer wall 21 under the action of the airflow so as to heat the outer side surface of the outer wall 21, which can also prevent icing over the outer side surface.

The inner wall 22 is described in detail below. The inner wall 22 is shaped as a cone that is smaller than the nose cone portion 1, and has a cone tip facing the nose cone portion 1, and the through hole 221 is formed at a conical tip portion of the inner wall 22.

With this structure, the airflow channel 3 between the nose cone portion 1 and the inner wall 22 is narrow, and the through hole 221 may be as close to the nose cone portion 1 as possible, so as to prevent heat loss of the hot air in the airflow channel 3 and achieve better heating effect of the hot air on the nose cone portion 1. Of course, in other embodiments, the inner wall 22 may also be flat, as long as the nose cone portion 1 is in clearance-fit with the inner wall 22 to form the airflow channel 3 for hot air to enter.

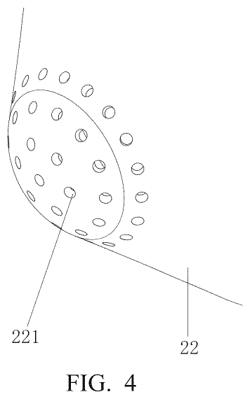

Referring to FIG. 4, as a preferred embodiment, a plurality of through holes 221 are provided.

Providing the plurality of through holes 221 can extend the range of hot air injection to further improve the heating effect on the nose cone portion 1.

As a preferred embodiment, a plurality of through holes 221 are evenly arranged and equally spaced at the conical tip portion of the inner wall 22.

The through holes 221 being evenly arranged and equally spaced at the conical tip portion of the inner wall 22 can achieve more uniform hot air injection to prevent icing due to a certain area of the nose cone portion 1 not being heated by the hot air.

As a preferred embodiment, the air hole 11 is arranged at an end portion of the nose cone portion 1 close to the outer wall 21.

The air hole 11 being arranged at one end of the nose cone portion 1 close to the outer wall 21 enables the hot air to flow to the outer surface of the outer wall 21 immediately after flowing out of the airflow channel 3, so as to prevent decrease of the heating effect on the outer wall 21 due to heat loss of the hot air after staying in the outside for a long time. In addition, since the through hole 221 is arranged at the cone tip of the inner wall 22, the hot air flows through a longer path in the airflow channel 3, which is also conducive to improving the heating effect on the nose cone portion 1.

As a preferred embodiment, a plurality of air holes 11 are provided, and the plurality of air holes 11 are evenly arranged in a circumferential direction of the nose cone portion 1.

With this structure, the hot air flows more uniformly in the direction from the airflow channel 3 to the outside, which can heat the outer wall 21 more fully, preventing local icing over the outer wall 21.

As a preferred embodiment, the main body 2 further includes a transition section 23, the inner wall 22 is connected to the outer wall 21 via the transition section 23, and an angle between the transition section 23 and an axial extending line of the inlet cone is an acute angle.

The transition section 23 slopes up and is connected to the outer wall 21, and the hot air flows out of the air hole 11 along the transition section 23 when flowing from the airflow channel 3 to the outside. On the one hand, the resistance to the hot air is small when the hot air flows out, and on the other hand, the hot air flows out in a direction that is inclined towards the outer wall 21, which prevents heat waste due to the outer wall 21 being unable to be exposed to the hot air that is blown vertically upwards.

As a preferred embodiment, the air hole 11 is an inclined hole having an inclination angle the same as the angle of the transition section 23.

The resistance to the hot air flowing out of the air hole 11 along the transition section 23 is smaller, achieving higher directionality.

An embodiment further provides an aero-engine including the inlet cone described above.

Cold air flows towards the outer wall 21 at the rear along the outer side surface of the nose cone portion 1 of the inlet cone of the aero-engine, and since the outer side surface of the outer wall 21 (i.e., the second outer profile line 4) is curved and drawn down towards the axis of the main body 2 in the direction away from the first outer profile line 3, an air stagnation area is formed between an extension line of the first outer profile line 3 and the second outer profile line 4, and there is less cold air flowing in the air stagnation area, that is, the heat taken away by the cold air from the surface of the outer wall 21 is correspondingly reduced, such that the outer wall 21 of the inlet cone is less prone to icing up, thereby improving the engine efficiency.

Although specific implementations of the present disclosure have been described above, those skilled in the art should understand that these are merely examples, and the scope of protection of the present disclosure is defined by the appended claims. Those skilled in the art can make various changes or modifications to these implementations without departing from the principle and spirit of the present disclosure, but all the changes or modifications fall within the scope of protection of the present disclosure.

1-11. (canceled)

12. An inlet cone, comprising a main body and a nose cone portion, wherein the main body comprises an outer wall; the nose cone portion is connected to an end portion of the outer wall; and an outer side surface of the nose cone portion has a first outer profile line, and an outer side surface of the outer wall has a second outer profile line, the second outer profile line being curved and drawn down towards an axis of the main body in a direction away from the first outer profile line.

13. The inlet cone according to claim 12, wherein the second outer profile line is smoothly joined with and tangent to the first outer profile line.

14. The inlet cone according to claim 12, wherein the main body further comprises an inner wall arranged at the end portion of the outer wall, and a through hole is formed in the inner wall; and the nose cone portion is sleeved on an outer side of the inner wall in a clearance-fit manner to form an airflow channel, and an air hole is formed in the nose cone portion.

15. The inlet cone according to claim 14, wherein the inner wall is cone-shaped and has a cone tip facing the nose cone portion, and the through hole is arranged at a conical tip portion of the inner wall.

16. The inlet cone according to claim 15, wherein two or more through holes are provided.

17. The inlet cone according to claim 16, wherein the plurality of through holes are evenly arranged and equally spaced at the conical tip portion of the inner wall.

18. The inlet cone according to claim 14, wherein the air hole is arranged at an end portion of the nose cone portion close to the outer wall.

19. The inlet cone according to claim 18, wherein a plurality of air holes are provided and are evenly arranged in a circumferential direction of the nose cone portion.

20. The inlet cone according to claim 18, wherein the main body further comprises a transition section, the inner wall is connected to the outer wall via the transition section, and an angle between the transition section and an axial extending line of the inlet cone is an acute angle.

21. The inlet cone according to claim 20, wherein the air hole is an inclined hole having an inclination angle the same as the angle of the transition section.

22. An aero-engine, comprising an inlet cone according to claim 12.
